(19) United States
(12) Patent Application Publication
(10) Pub. No.: US 2014/0059404 A1
(43) Pub. Date: Feb. 27, 2014

(54) MEMORY CONTROL DEVICE, MEMORY DEVICE, INFORMATION PROCESSING SYSTEM AND MEMORY CONTROL METHOD

(71) Applicant: Sony Corporation, Tokyo (JP)

(72) Inventors: Hideaki Okubo, Saitama (JP); Keiichi Tsutsui, Kanagawa (JP); Yasushi Fujinami, Tokyo (JP); Kenichi Nakanishi, Tokyo (JP); Naohiro Adachi, Tokyo (JP); Ken Ishii, Tokyo (JP); Tatsuo Shinbashi, Tokyo (JP)

(73) Assignee: SONY CORPORATION, Tokyo (JP)

(21) Appl. No.: 13/953,960

(22) Filed: Jul. 30, 2013

(30) Foreign Application Priority Data
Aug. 24, 2012 (JP) 2012-184743

(51) Int. Cl. G06F 11/10; G06F 12/08

(52) U.S. Cl. CPC G06F 11/1016; G06F 12/08
USPC 714/768; 711/117

(57) ABSTRACT

There is provided a memory control device, including a request determining unit that determines a type of a request, and a control unit that writes read data read from a memory cell array in the memory cell array in units of predetermined pages of the memory cell array when the request is a refresh request, and divides the page of write data into units of groups and writes the page of the write data in the memory cell array over twice or more when the request is a write request.

### BACKGROUND

The present technology relates to a memory control device. Particularly, the present technology relates to a memory control device for a non-volatile memory, a memory device, an information processing system, a processing method therein, and a program causing a computer to execute the method.

In information processing systems, dynamic random access memories (DRAMs) or the like are used as work memories. Typically, the DRAM is a non-volatile memory and loses storage content when supply of electric power stops. Meanwhile, in recent years, non-volatile memories (NVMs) have been used. The non-volatile memories are roughly divided into flash memories supporting data access using a large size as a unit and non-volatile random access memories (NVRAMs) capable of performing high-speed random access in small units. Here, as a representative example of a flash memory, there is a NAND flash memory. Meanwhile, examples of a non-volatile random access memory include a resistance RAM (ReRAM), a phase-change RAM (PCRAM), and a magnetoresistive RAM (MRAM).

The ReRAM is a non-volatile memory using a variable resistive element, does not have to perform erasing in units of blocks before writing data, and can directly rewrite only a necessary page. Meanwhile, since the ReRAM has a limitation to a write current on a memory cell, a technique of dividing pages serving as a write target and performing writing has been proposed (for example, JP 2010-182373 A).

### SUMMARY

In the above-mentioned related art, an attempt to suppress a write current is made by dividing pages serving as a write target and then performing writing. The suppressing of the current is effective in reducing power consumption in memories other than a ReRAM. Meanwhile, there are cases in which a change in storage content is small depending on content written in a memory, and in this case, when pages are divided and then writing is performed, more time than necessary may be spent.

It is desirable to perform writing in which a change in storage content is small at a high speed.

According to a first embodiment of the present technology, there is provided a memory control device and a control method of the same, the memory control device including a request determining unit that determines a type of a request, and a control unit that writes read data read from a memory cell array in the memory cell array in units of predetermined pages of the memory cell array when the request is a refresh request, and divides the page of write data into units of groups and writes the page of the write data in the memory cell array over twice or more when the request is a write request. Thus, there is an effect by which writing based on the refresh request can be processed at a speed higher than writing based on the write request.

Further, according to the first embodiment, a bit number of the group may be decided based on an amount of current allowed in the memory cell array. Thus, there is an effect by which the write request can be performed in units in which the amount of current allowed in the memory cell array is considered.

Further, according to the first embodiment, the memory control device may further include an error processing unit that performs error detection of the read data. The control unit does not necessarily perform writing to the memory cell array when a number of errors detected in the error detection does not satisfy a predetermined requirement. Thus, there is an effect by which writing based on the refresh request is performed only when the number of detected errors satisfies a predetermined requirement.

Further, according to the first embodiment, the memory control device may further include an error processing unit that performs error detection and correction of the read data. The control unit does not necessarily perform writing to the memory cell array when a number of errors detected in the error detection is larger than an error correctable number. Thus, there is an effect by which writing based on the refresh request is performed only when the number of detected errors is larger than an error correctable number.

Further, according to the first embodiment, the memory control device may further include a verifying processing unit that reads data from the memory cell array in units of pages after the data is written in response to the refresh request or the write request, and verifies whether or not writing has been properly performed. Thus, there is an effect by which it is verified whether or not writing has been successfully performed based on the refresh request or the write request.

Further, according to a second embodiment of the present technology, there is provided a memory device including a memory cell array including a plurality of memory cells, a request determining unit that determines a type of a request, and a control unit that writes read data read from the memory cell array in the memory cell array in units of predetermined pages of the memory cell array when the request is a refresh request, and divides the page of write data into units of groups and writes the page of the write data in the memory cell array over twice or more when the request is a write request. Thus, there is an effect by which writing on the memory cell array based on the refresh request can be processed at a higher speed than writing based on the write request.

Further, according to a third embodiment of the present technology, there is provided an information processing system including a memory cell array including a plurality of memory cells, a host computer that issues a command to the memory cell array, a command determining unit that determines a type of the command, and a control unit that writes read data read from the memory cell array in the memory cell array in units of predetermined pages of the memory cell array when the command is a refresh command, and divides the page of write data into units of groups and writes the page of the write data in the memory cell array over twice or more when the command is a write command Thus, there is an effect by which writing on the memory cell array based on the refresh command from the host computer can be processed at a higher speed than writing based on the write command.

According to the embodiments of the present technology described above, there is an excellent effect by which writing in which a change in storage content is small can be performed at a high speed.

### BRIEF DESCRIPTION OF THE DRAWINGS

FIG. 1 is a diagram illustrating an exemplary configuration of an information processing system according to an embodiment of the present technology;

FIG. 2 is a diagram illustrating an exemplary configuration of a memory 300 according to the embodiment of the present technology;

FIG. 3 is a diagram illustrating an example of a structure of a memory cell array 310 according to the embodiment of the present technology;

FIG. 4 is a diagram illustrating an exemplary circuit of a memory cell 313 according to the embodiment of the present technology;

FIG. 5 is a diagram illustrating a resistance distribution when the memory cell 313 according to the embodiment of the present technology is in a normal state;

FIG. 6 is a diagram illustrating a changed resistance distribution of the memory cell 313 according to the embodiment of the present technology;

FIG. 7 is a diagram illustrating an example of a structure of data stored in the memory cell array 310 according to the embodiment of the present technology;

FIG. 8 is a diagram illustrating an example of a structure of a physical page stored in the memory cell array 310 according to the embodiment of the present technology;

FIG. 9 is a diagram illustrating examples of buffers held in a buffer 340 according to the embodiment of the present technology;

FIG. 10 is a diagram illustrating a concrete example (reset target specifying) held in the buffer 340 according to the embodiment of the present technology;

FIG. 11 is a diagram illustrating a concrete example (reset verifying) held in the buffer 340 according to the embodiment of the present technology;

FIG. 12 is a diagram illustrating a concrete example (set target specifying) held in the buffer 340 according to the embodiment of the present technology;

FIG. 13 is a diagram illustrating a concrete example (set verifying) held in the buffer 340 according to the embodiment of the present technology;

FIG. 14 is a diagram illustrating an example of a command processing procedure of a memory controller 200 according to the embodiment of the present technology;

FIG. 15 is a diagram illustrating an example of a processing procedure of a write command process according to the embodiment of the present technology;

FIG. 16 is a diagram illustrating an example of a processing procedure of a physical page reset process (step S920) according to the embodiment of the present technology;

FIG. 17 is a diagram illustrating an exemplary progression of physical page resetting at the time of a write process according to the embodiment of the present technology;

FIG. 18 is a diagram illustrating an example of a processing procedure of a physical page set process (step S940) according to the embodiment of the present technology;

FIG. 19 is a diagram illustrating an example of a processing procedure of a read command process according to the embodiment of the present technology;

FIG. 20 is a diagram illustrating an example of a processing procedure of a refresh command process according to the embodiment of the present technology;

FIG. 21 is a diagram illustrating an example of a processing procedure of a refresh request process according to the embodiment of the present technology;

FIG. 22 is a diagram illustrating an example of a processing procedure of a physical page refresh reset process (step S960) according to the embodiment of the present technology;

FIG. 23 is a diagram illustrating an exemplary progression of physical page refresh resetting at the time of a refresh process according to the embodiment of the present technology;

FIG. 24 is a diagram illustrating an example of a processing procedure of a physical page refresh set process (step S980) according to the embodiment of the present technology; and

FIG. 25 is a diagram illustrating a relation between a resistance distribution and a threshold value of a memory cell 313 according to a modified example of the embodiment of the present technology.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, modes (hereinafter referred to as “embodiments”) for carrying out the present technology will be described. The description will proceed in the following order.

1. First embodiment (refresh control)

2. Modified example (threshold value change)

### 1. First Embodiment

[Configuration of Information Processing System]

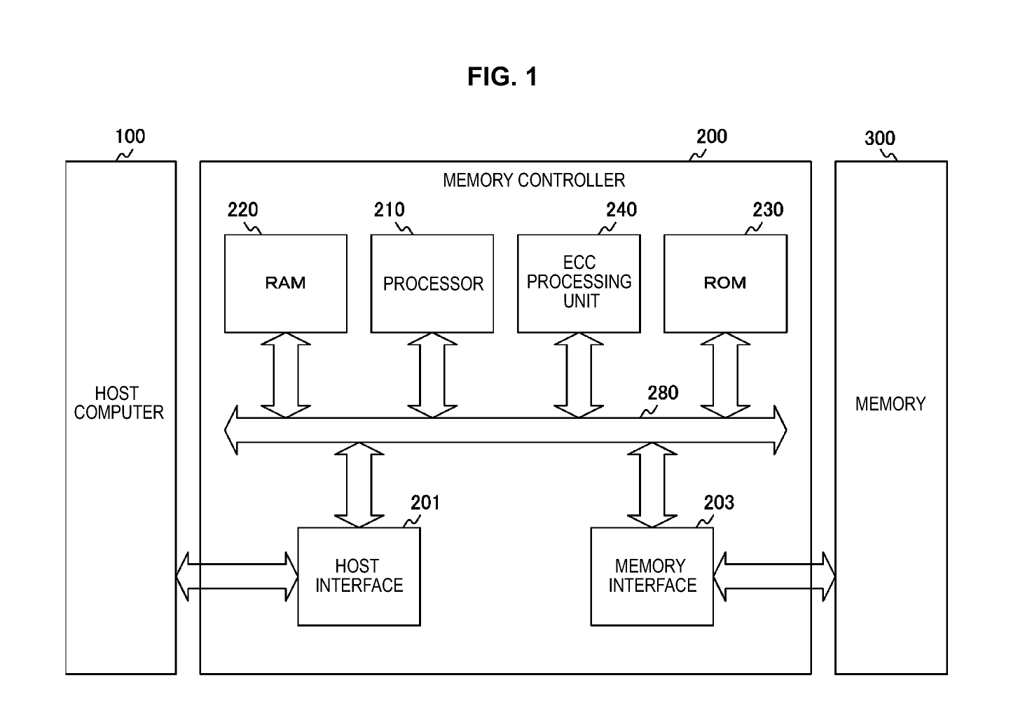

FIG. 1 is a diagram illustrating an exemplary configuration of an information processing system according to an embodiment of the present technology. The information processing system includes a host computer 100, a memory controller 200, and a memory 300. The memory controller 200 and the memory 300 configure a storage system.

The host computer 100 issues a command to request reading or writing of data, negative refreshing, or the like to the memory 300.

The memory controller 200 communicates with the host computer 100 to receive the command, and executes data writing to the memory 300 and data reading from the memory 300. Upon receiving a write command, the memory controller 200 gives an instruction to write data received from the host computer 100 in the memory 300. Further, upon receiving a read command, the memory controller 200 reads data from the memory 300, and transfers the read data to the host computer 100. Further, upon receiving a refresh command, the memory controller 200 reads data from the memory 300, and gives an instruction to write the read data in the memory 300 again.

When the host computer 100 executes the write command, the read command, or the refresh command, a logical address is used as an address representing positional information of data in the memory controller 200.

The memory controller 200 includes a processor 210, a RAM 220, a ROM 230, an ECC processing unit 240, a host interface 201, and a memory interface 203.

The processor 210 controls the memory controller 200 in general. The processor 210 executes software stored in the ROM 230. The processor 210 interprets the command issued from the host computer 100, and supplies a necessary request to the memory 300. The processor 210 is an example of a command determining unit according to an embodiment of the present technology.

The RAM 220 is a volatile memory and used as a working memory of the processor 210 or a region for temporarily holding data used to manage the memory 300. The RAM 220 is also used as a region for temporarily holding data to be transferred between the host computer 100 and the memory controller 200 and a region for temporarily holding data to be transferred between the memory controller 200 and the memory 300. The ROM 230 is a memory storing a software program used to control the storage system.

The ECC processing unit 240 generates an error correcting code (ECC) of data to be recorded in the memory 300, and executes an error correcting process of data read from the memory 300. The ECC processing unit 240 is an example of an error processing unit according to an embodiment of the present technology.

The host interface 201 is connected with the host computer 100, and receives reception of the command from the host computer 100 and receives/transmit data from/to the host computer 100.

The memory interface 203 is connected with the memory 300, transmits a request to the memory 300, transmits write data, and receives read data.

[Configuration of Memory]

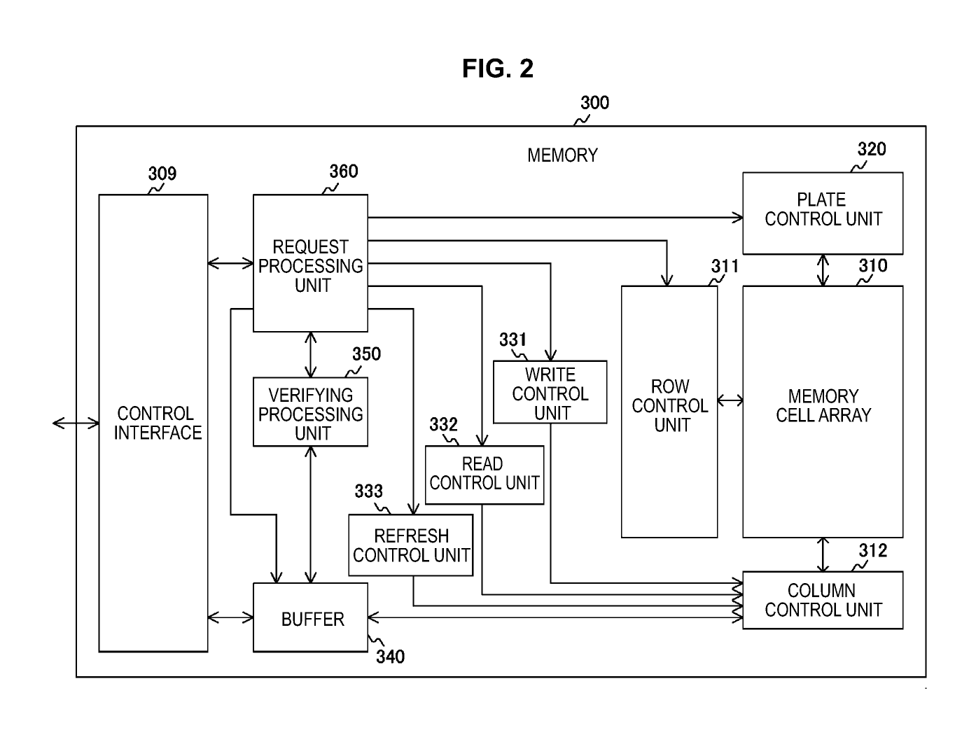

FIG. 2 is a diagram illustrating an exemplary configuration of the memory 300 according to the embodiment of the present technology. The memory 300 includes a memory cell array 310, a row control unit 311, a column control unit 312, and a plate control unit 320. The memory 300 further includes a write control unit 331, a read control unit 332, a refresh control unit 333, a buffer 340, a verifying processing unit 350, and a request processing unit 360.

The memory 300 further includes a control interface 309 serving as an interface with the memory controller 200. The control interface 309 serves to receive a request, a physical address and a parameter from the memory controller 200, receive write data to be written in the memory cell array 310, transmit read data read from the memory cell array 310, and perform reception and transmission of control data.

The memory cell array 310 is a memory cell array including a plurality of memory cells, and many memory cells each storing one binary value for each bit are arranged in a two-dimensional (2D) (matrix form) form. A unit of a request from the memory controller 200 to access the memory cell array 310 is a physical page unit. A physical page is allocated a physical page address.

The row control unit 311 specifies a row address of the memory cell array 310 and performs access control according to an instruction from the request processing unit 360. The column control unit 312 specifies a column address of the memory cell array 310 and performs access control according to an instruction from the request processing unit 360. The plate control unit 320 controls a plate voltage for causing a cell current to flow to the memory cell of the memory cell array 310.

The write control unit 331 executes control for performing writing to the memory cell array 310. The read control unit 332 executes control for performing reading from the memory cell array 310. The refresh control unit 333 executes control for performing refreshing on the memory cell array 310. The write control unit 331 and the refresh control unit 333 are examples of a control unit according to an embodiment of the present technology.

The buffer 340 is a storage region of a buffer holding data necessary for processing each request. A configuration of the buffer 340 will be described later.

The verifying processing unit 350 verifies whether or not data has been properly written in the memory cell array 310.

The request processing unit 360 processes a request from the memory controller 200. The request processing unit 360 instructs the write control unit 331 to perform control when a request from the memory controller 200 is a write request. The request processing unit 360 instructs the read control unit 332 to perform control when a request from the memory controller 200 is a read request. The request processing unit 360 instructs the refresh control unit 333 to perform control when a request from the memory controller 200 is a refresh request. The request processing unit 360 is an example of a request determining unit according to an embodiment of the present technology.

Further, the memory controller 200 or the portions excluding the memory cell array 310 in the memory 300 are an example of a memory control device according to an embodiment of the present technology. Further, the memory 300 is an example of a memory device according to an embodiment of the present technology.

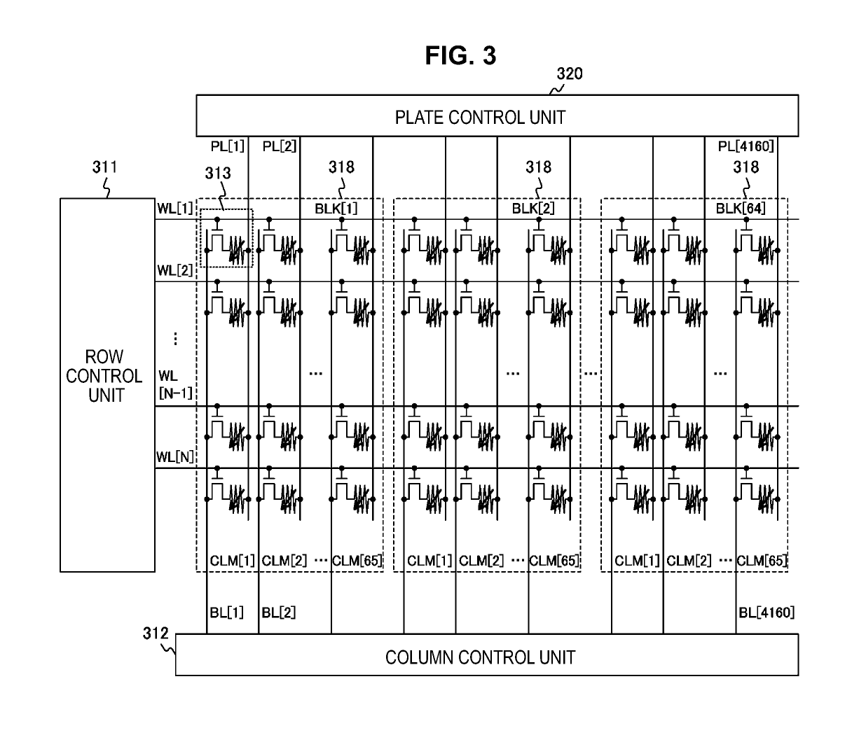

FIG. 3 is a diagram illustrating an example of a structure of the memory cell array 310 according to the embodiment of the present technology. In the memory cell array 310, memory cells 313 are arranged in the form of a matrix in which N rows (N is an integer of 2 or more) are arranged in the row direction and 4160 columns are arranged in the column direction. The memory cells 313 are connected to word lines WL, bit lines BL, and plate lines PL. In FIG. 3, N word lines WL are represented by WL[1] to WL[N], 4160 bit lines BL are represented by BL[1] to BL[4160], and 4160 plate lines PL are represented by PL[1] to PL[4160]. The word line WL is connected to the row control unit 311, and the bit line BL is connected to the column control unit 312.

In this example, the memory cells of the memory cell array 310 in the row direction are divided into 64 blocks BLK 318. Therefore, each of the blocks BLK 318 is configured with N×65 memory cells. In FIG. 3, the 64 blocks BLK 318 are represented by BLK[1] to BLK[64]. Each of the blocks BLK 318 is connected to 65 bit lines BL. In the block BLK 318, the 65 bit lines BL are represented by column lines CLM[1] to CLM[65].

A set of 4160 memory cells connected to the word line WL is referred to as a physical page. The memory controller 200 accesses the memory 300 in units of physical pages. A physical page is allocated a specific physical page address.

A set of 64 memory cells selected from each of the 64 blocks BLK 318 are referred to as a group. The number of memory cells belonging to a one group is decided based on an amount of current allowed in the memory cell array 310. Among the 4160 memory cells connected to a single word line WL, a set of memory cells connected to CLM[1] is referred to as a first group, and a set of memory cells connected to CLM[2] is referred to as a second group. Similarly, a set of memory cells connected to CLM[65] is referred to as a 65th group.

The row control unit 311 selects the word line WL designated based on a physical page address input from the request processing unit 360, and drives the selected word line WL at a predetermined voltage during a predetermined period of time. A voltage of the word line WL is a voltage used to cause a memory cell connected to the word line WL to enter a state in which writing, reading, or refreshing can be performed. This voltage is referred to as a word line voltage, and becomes active at a high level. The row control unit 311 controls an applying timing, a duration, and an applying voltage of a pulse having a peak value as a word line voltage.

The column control unit 312 includes a sense amplifier that reads electric potential of the bit line BL. Thus, data of 4160 bits can be collectively read.

The plate control unit 320 controls a plate voltage used to cause a cell current to flow to the memory cell of the memory cell array 310. In the plate voltage, a direction of a memory cell current is decided based on a voltage difference with the voltage of the bit line BL. For this reason, the plate control unit 320 performs control such that a magnitude relation between the plate voltage and the bit line voltage at the time of setting is opposite to that at the time of resetting.

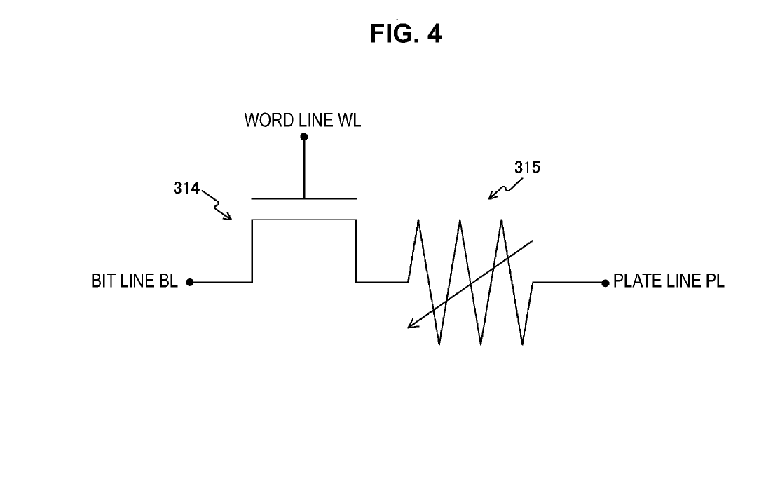

FIG. 4 is a diagram illustrating an exemplary circuit of the memory cell 313 according to the embodiment of the present technology. Here, under the assumption that the memory cell 313 is a variable resistive element, the memory cell 313 is assumed to be configured with one access transistor 314 and one variable cell resistor 315. One end of the variable cell resistor 315 is connected to the plate line PL, and the other end thereof is connected to a source terminal of the access transistor 314. A drain terminal of the access transistor 314 is connected to the bit line BL, and a gain terminal thereof is connected to the word line WL.

When the plate line PL is higher in voltage than the bit line BL by a predetermined voltage, the variable cell resistor 315 enters a low resistive state. The operation causing the variable cell resistor 315 to enter the low resistive state is referred to as a set operation. Meanwhile, when the bit line BL is higher in voltage than the plate line PL, the variable cell resistor 315 enters a high resistive state. The operation causing the variable cell resistor 315 to enter the high resistive state is referred to as a reset operation.

As the resistive state is reversely changed between the low resistive state and the high resistive state, a memory in which each memory cell stores one bit is implemented. A non-volatile memory in which data is held even after applying of a voltage stops is implemented. The following description will proceed with an example in which data read from a cell in the low resistive state is set to “0,” and data read from a cell in the high resistive state is set to “1,” but a correspondence relation of “0” and “1” may be reversed.

[Resistive State of Memory]

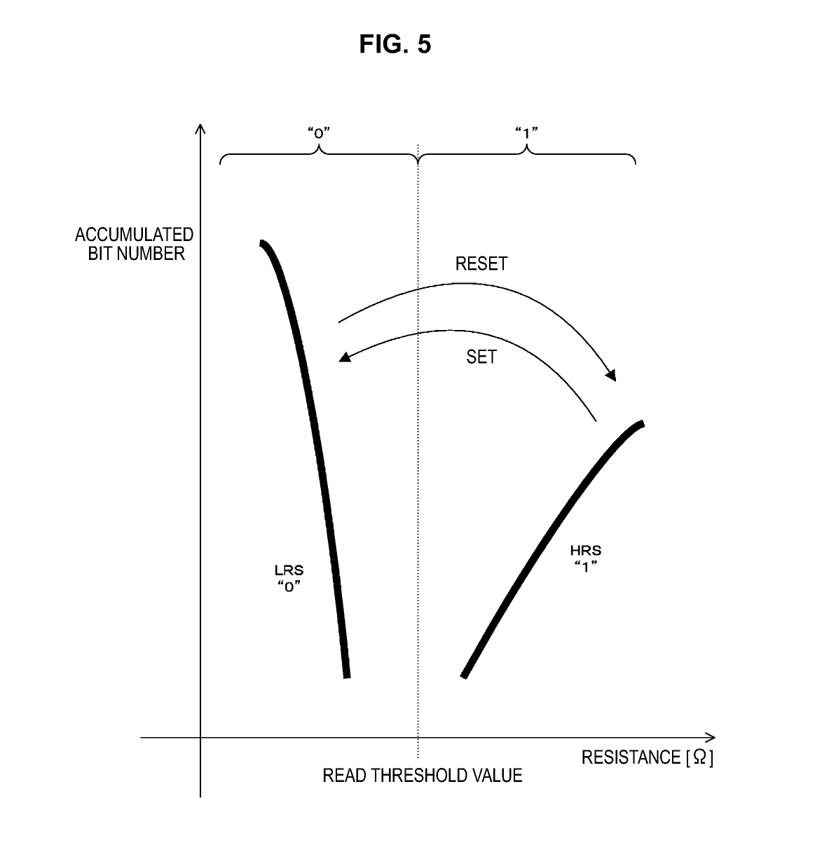

FIG. 5 is a diagram illustrating a resistance distribution when the memory cell 313 according to the embodiment of the present technology is in the normal state. The memory cell 313 transitions to the low resistive state (LRS) through the set operation, and transitions to the high resistive state (HRS) through the reset operation. When data is read from the memory cell array 310, the resistive state is determined based on a reference resistance value represented by a read threshold value.

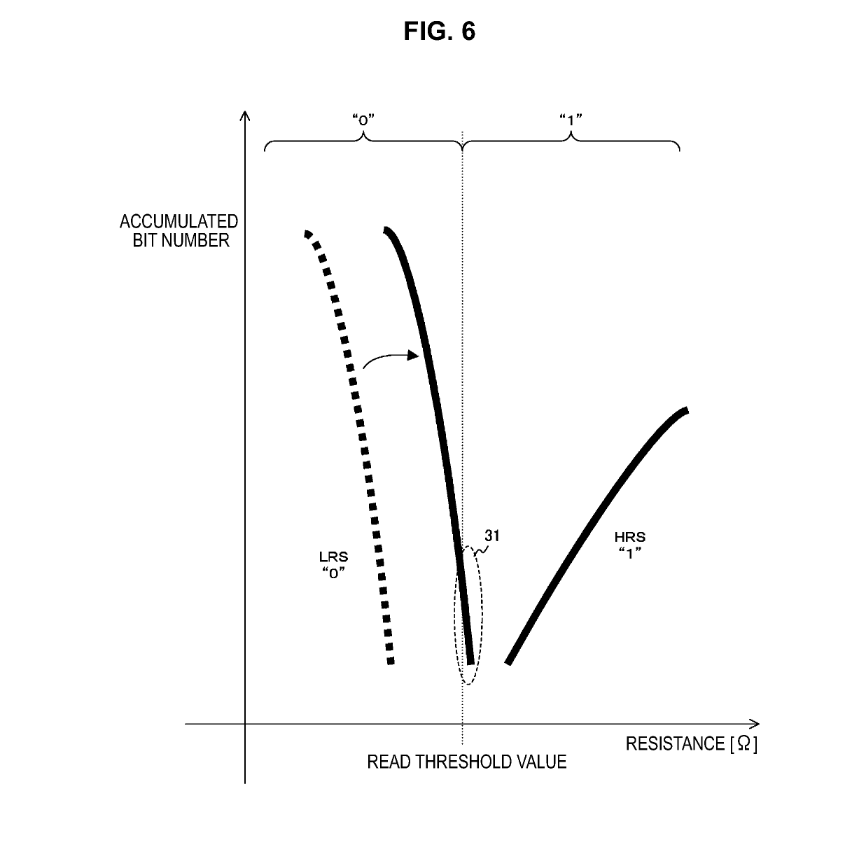

FIG. 6 is a diagram illustrating a changed resistance distribution of the memory cell 313 according to the embodiment of the present technology. FIG. 6 is an example in which the memory cell transitioned to the LRS by the set operation is read as the HRS. In a variable resistance memory, due to stress caused by a voltage applied to the memory cell at the time of data reading or a temporal change, the distribution of the memory cell changes, and erroneous data is likely to be read. In this example, the resistive state that was supposed to transition to the LRS changes to a high resistive side, and when the read threshold value is used as a reference, a part of the resistive state 31 is interpreted as the HRS.

Here, the example in which erroneous data is read as the distribution of the memory cell in the LRS changes has been described, but the distribution of the memory cell in the HRS may change for the same reason. Therefore, a value of the memory cell transitioned to the HRS by the reset operation may be read as the LRS.

In this regard, in this embodiment, rewriting to a proper resistive state is assumed to be performed by the refresh command before the resistive state is changed. Further, the speed of the refresh command process is changed, and thus the speed of the storage system is increased.

[Data Structure]

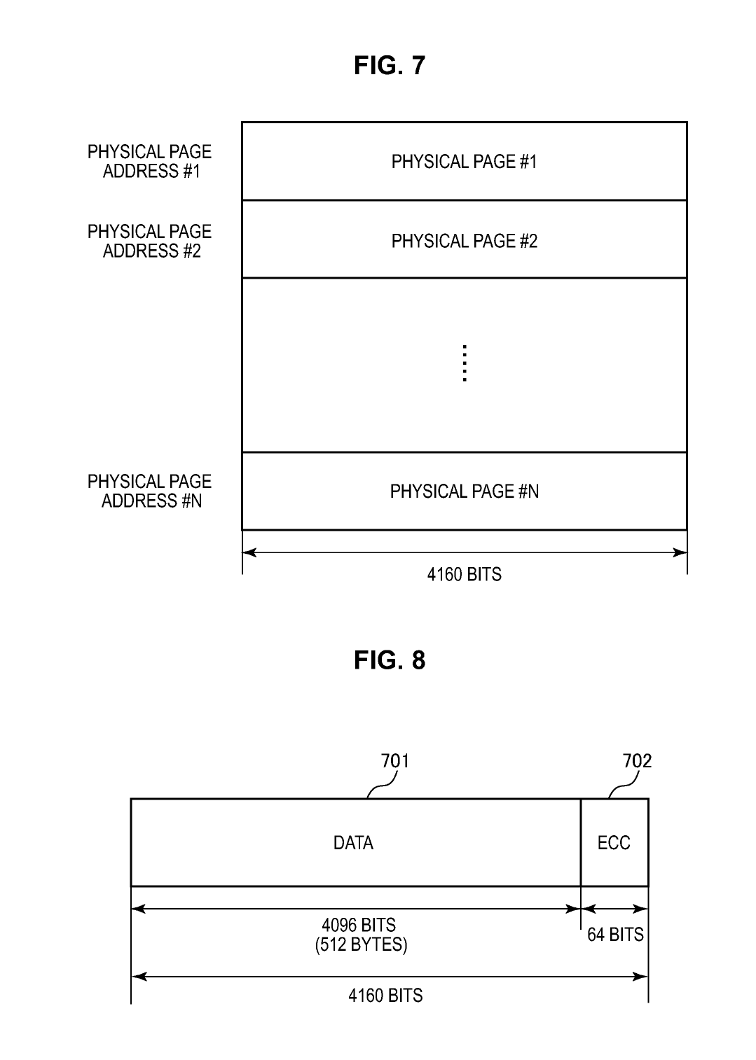

FIG. 7 is a diagram illustrating an example of a structure of data stored in the memory cell array 310 according to the embodiment of the present technology.

As described above, in the memory cell array 310, the memory cells 313 are arranged in the form of a matrix in which N rows are arranged in the row direction and 4160 columns are arranged in the column direction. Further, each of N words in the row direction is used as a physical page and allocated as a physical address. In other words, the memory cell array 310 is configured with N physical pages and specified by physical addresses of “1” to “N.” At this time, each physical page has 4160 bits.

FIG. 8 is a diagram illustrating an example of a structure of a physical page stored in the memory cell array 310 according to the embodiment of the present technology.

The physical page is configured with data 701 of 512 bytes (4096 bits) and an ECC 702 of 64 bits. The ECC 702 is an error correcting code used to correct an error in the data 701 and is assumed to have correction capability of 4 bits.

[Type of Buffer]

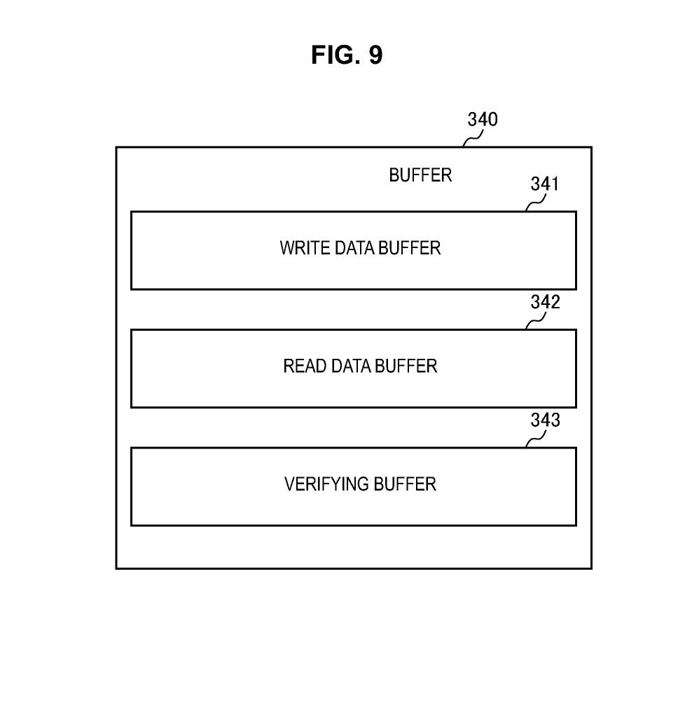

FIG. 9 is a diagram illustrating examples of buffers held in the buffer 340 according to the embodiment of the present technology. In this example, a write data buffer 341, a read data buffer 342, and a verifying buffer 343 are assumed to be disposed in the buffer 340

The write data buffer 341 is a buffer holding write data serving as a write target on the memory cell array 310. The read data buffer 342 is a buffer holding read data read from the memory cell array 310. The verifying buffer 343 is a buffer holding a verification result obtained by the verifying processing unit 350. The verifying buffer 343 is used even when a bit serving as a set target or a reset target is specified. Each buffer has the width of 4160 bits, similarly to the physical page.

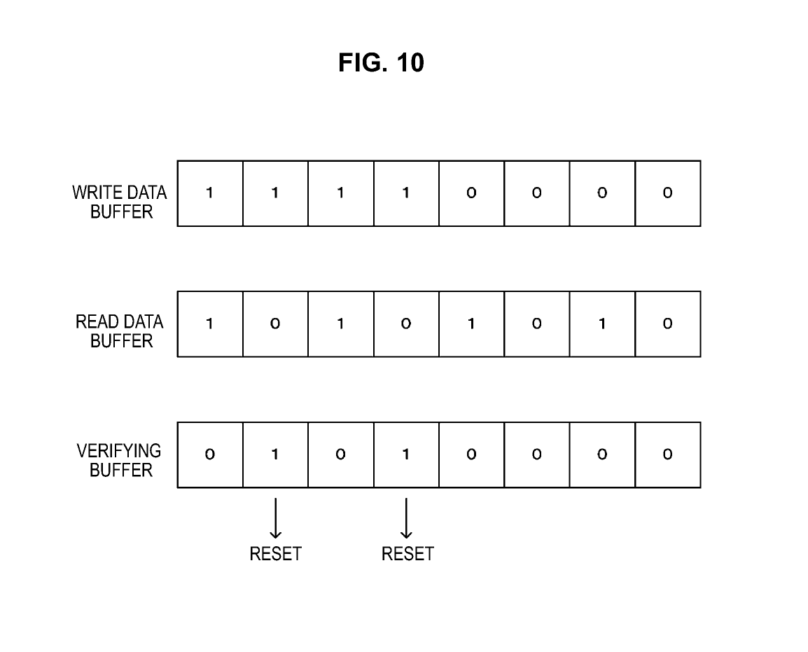

FIG. 10 is a diagram illustrating a concrete example held in the buffer 340 according to the embodiment of the present technology. In the following example, only 8 corresponding bits are illustrated among the 4160 bits of each buffer.

The write data buffer 341 holds “11110000” as write data, and the read data buffer 342 holds “10101010” as pre-read data. Here, the memory cell 313 to be reset is assumed to be specified, and the result is assumed to be held in the verifying buffer 343. In other words, a memory in which already written data is “0” and data to be written is “1” is specified as a memory cell to be reset from “0” to “1.” In this example, the verifying buffer 343 holds “01010000,” and second and fourth memory cells are specified as memory cells to be reset.

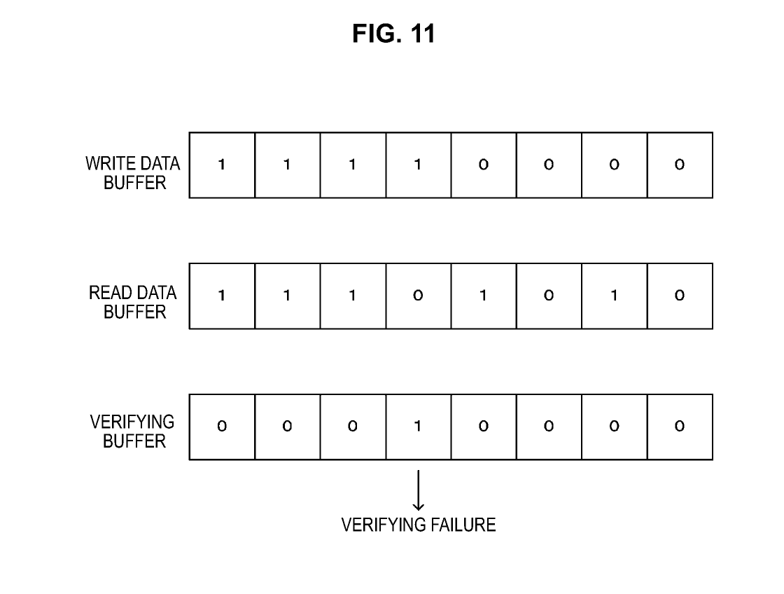

FIG. 11 is a diagram illustrating a concrete example held in the buffer 340 according to the embodiment of the present technology.

The write data buffer 341 holds “11110000” as write data, and the read data buffer 342 holds “11101010” as data read for verification. Here, verification is assumed to be performed such that content held in the write data buffer 341 is compared to content held in the read data buffer 342, and the result is assumed to be held in the verifying buffer 343. In other words, a memory cell in which original write data does not actually match written data is a memory cell that fails to be verified. In this example, the verifying buffer 343 holds “00010000,” and this represents the fourth memory cell fails to be verified.

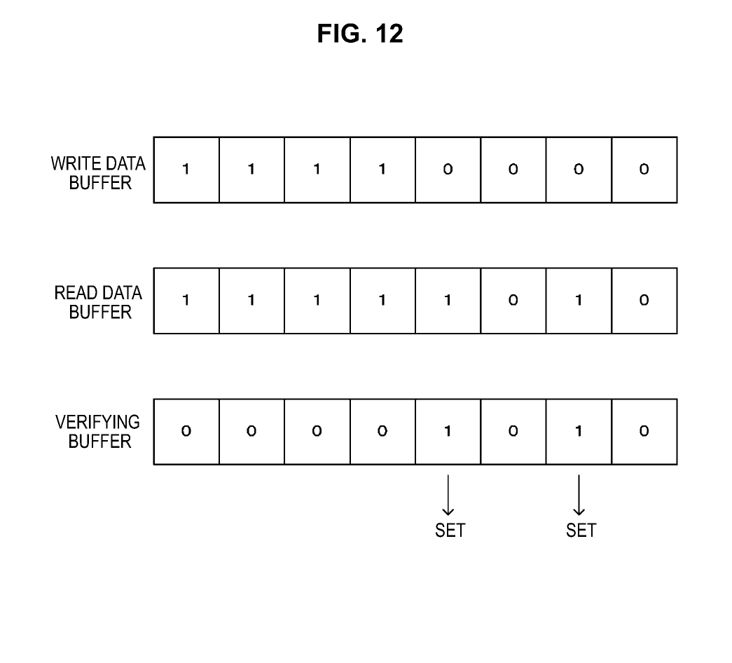

FIG. 12 is a diagram illustrating a concrete example held in the buffer 340 according to the embodiment of the present technology.

The write data buffer 341 holds “11110000” as write data, and the read data buffer 342 holds “10101010” as pre-read data. Here, the memory cell 313 to be reset is assumed to be specified, and the result is assumed to be held in the verifying buffer 343. In other words, a memory in which already written data is “1” and data to be written is “0” is specified as a memory cell to be set from “1” to “0.” In this example, the verifying buffer 343 holds “00001010,” and fifth and seventh memory cells are specified as memory cells to be set.

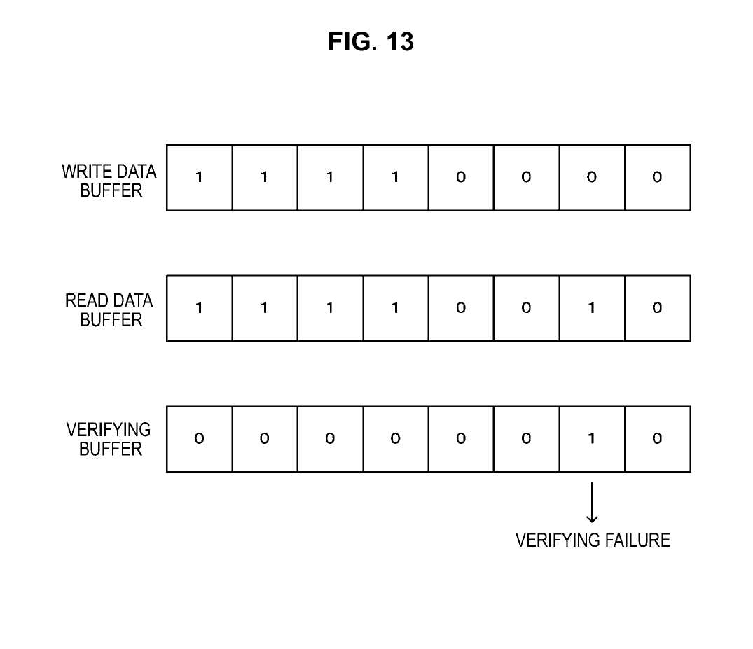

FIG. 13 is a diagram illustrating a concrete example held in the buffer 340 according to the embodiment of the present technology.

The write data buffer 341 holds “11110000” as write data, and the read data buffer 342 holds “11110010” as data read for verification. Here, verification is assumed to be performed such that content held in the write data buffer 341 is compared to content held in the read data buffer 342, and the result is assumed to be held in the verifying buffer 343. In other words, a memory cell in which original write data does not actually match written data is a memory cell that fails to be verified. In this example, the verifying buffer 343 holds “00000010,” and this represents the seventh memory cell fails to be verified.

[Operation of Information Processing System]

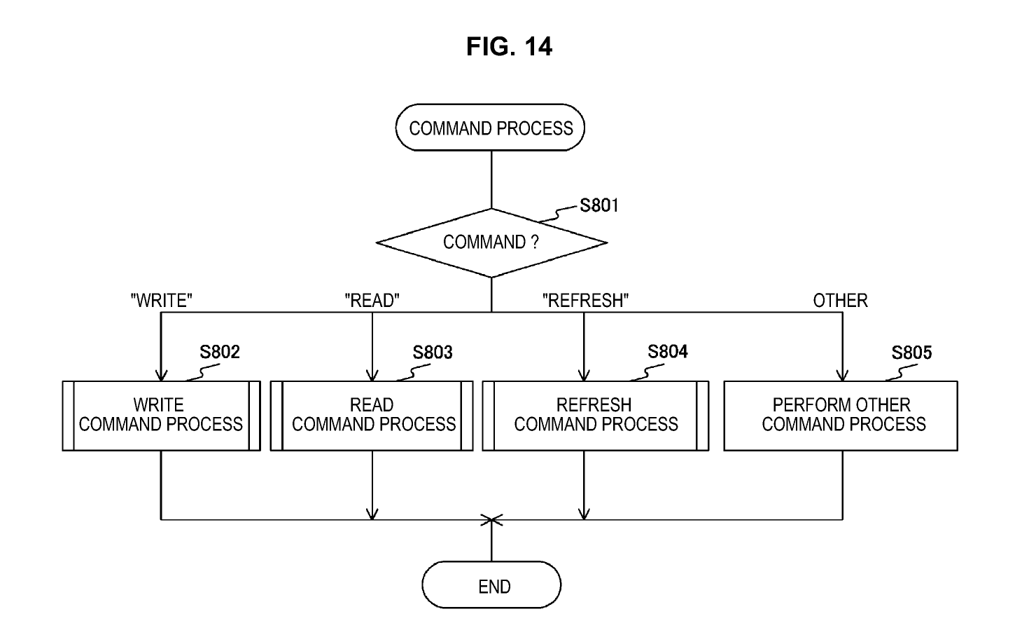

FIG. 14 is a diagram illustrating an example of a command processing procedure of the memory controller 200 according to the embodiment of the present technology.

Upon receiving a command from the host computer 100, the processor 210 of the memory controller 200 interprets the type of the command, and performs a corresponding process (step S801). In other words, when the command is the write command, the write command process is performed (step S802). Further, when the command is the read command, the read command process is performed (step S803). Further, when the command is the refresh command, the refresh command process is performed (step S804). A process corresponding to a command is performed even on any other command (step S805).

[Write Process]

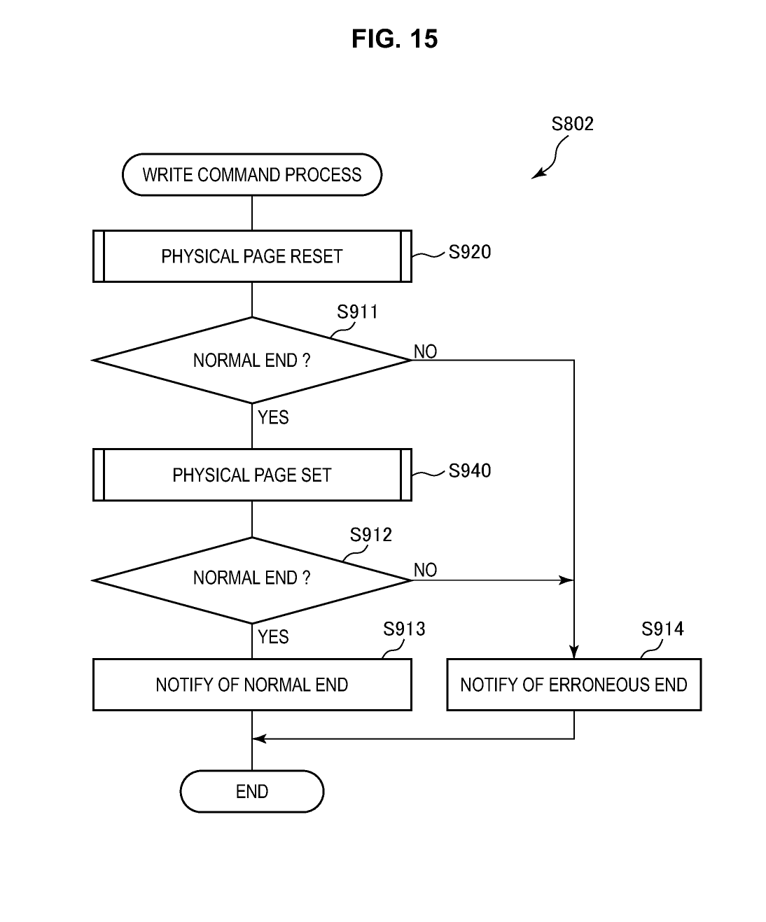

FIG. 15 is a diagram illustrating an example of a processing procedure of the write command process according to the embodiment of the present technology. As the write command process, the memory controller 200 transmits the write request to the memory 300. As a result, the request processing unit 360 performs a write operation by the following process.

Upon receiving the write request and the physical page address from the control interface 309, the request processing unit 360 starts a physical page write process. When the physical page write process starts, write data written in the memory cell array 310 is transferred from the control interface 309 to the write data buffer 341 and held in the write data buffer 341.

The request processing unit 360 executes a physical page reset process (step S920). Thereafter, the request processing unit 360 determines whether or not the physical page reset process executed in step S920 has ended normally (step S911). At this time, when it is determined that the physical page reset process has not ended normally (No in step S911), the request processing unit 360 notifies the memory controller 200 of the fact that the physical page write process has erroneously ended through the control interface 309 (step S914).

When it is determined that the physical page reset process has ended normally (Yes in step S911), the request processing unit 360 executes a physical page set process (step S940). Thereafter, the request processing unit 360 determines whether or not the physical page set process executed in step S940 has ended normally (step S912). At this time, when it is determined that the physical page set process has not ended normally (No in step S912), the request processing unit 360 notifies the memory controller 200 of the fact that the physical page write process has erroneously ended through the control interface 309 (step S914).

When it is determined that the physical page set process has ended normally (Yes in step S912), the request processing unit 360 notifies the memory controller 200 of the fact that the physical page write process has ended normally through the control interface 309 (step S913).

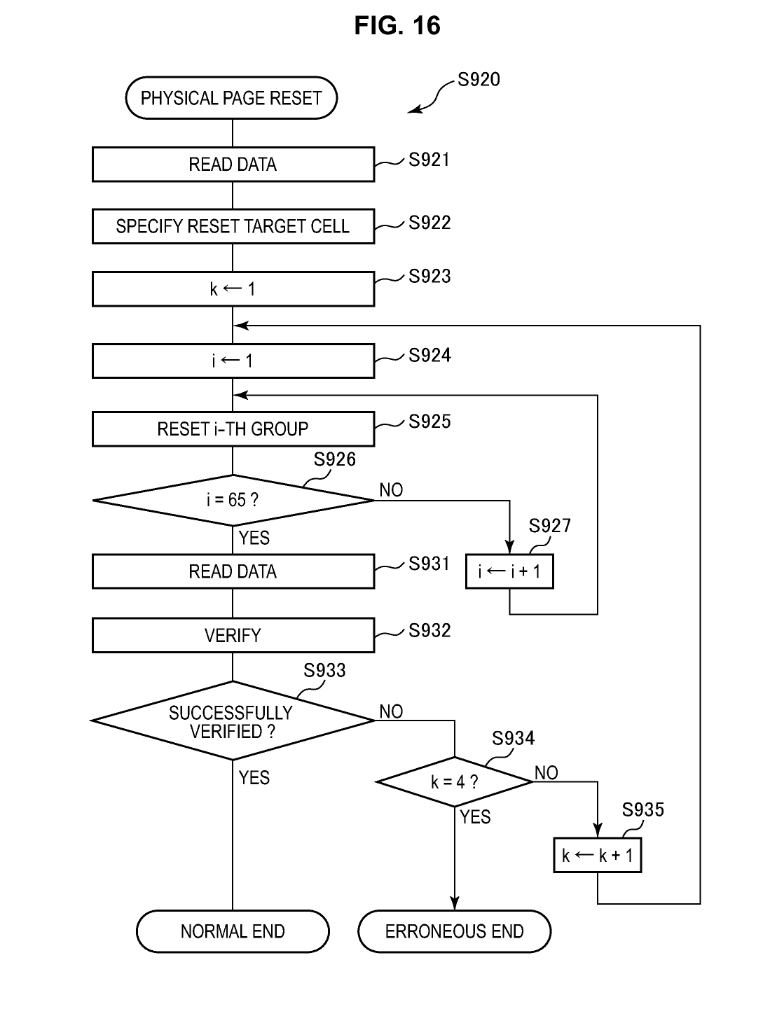

FIG. 16 is a diagram illustrating an example of a processing procedure of the physical page reset process (step S920) according to the embodiment of the present technology.

The request processing unit 360 supplies a control signal to the plate control unit 320, the row control unit 311, and the read control unit 332, and reads data from a designated physical page address (step S921). The read data is transferred to and held in the read data buffer 342 as pre-read data.

The request processing unit 360 compares the pre-read data held in the read data buffer 342 with the write data held in the write data buffer 341 in units of bits, and specifies a memory cell on which a reset process is to be executed (step S922). The memory cell on which the reset process is to be executed is a memory cell in which a value of data held in the write data buffer 341 is “1,” and a value of data held in the read data buffer 342 is “0.” This means that it is necessary to change a state of a corresponding memory cell from “0” (the low resistive state) to “1” (the high resistive state). As information of the memory cell on which the reset process is to be executed, “1” is set as a value of a bit corresponding to a memory cell on which the reset process is to be executed, “0” is set as a value of a bit corresponding to a cell in which it is unnecessary to execute the reset process, and the values are held in the verifying buffer 343.

The request processing unit 360 sets a value of a counter k counting the number of times that setting and verifying are repeatedly executed “1” (step S923).

The request processing unit 360 sets “1” to a value of a counter i deciding a group number on which the reset process is to be executed (step S924).

The request processing unit 360 supplies a control signal to the plate control unit 320, the row control unit 311, and the write control unit 331, and supplies information specifying a cell that is to be reset from the verifying buffer 343 to the column control unit 312. As a result, a reset pulse is applied to the memory cell array 310, and the reset operation is performed (step S925). Here, a memory cell to which the reset pulse is applied is a cell on which the reset process is to be executed among memory cells belonging to an i-th group of a designated physical page address.

The request processing unit 360 determines whether or not the value of the counter i representing the group number on which the reset operation has been performed is “65” (step S926). When it is determined that the value of the counter i is not “65” (No in step S926), “1” is added to the counter i (step S927), and the process of step S925 and subsequent steps is repeated. However, when it is determined that the value of the counter i has reached “65,” the reset operation of each group ends (Yes in step S926).

In order to verify the reset operation, the request processing unit 360 supplies a control signal to the plate control unit 320, the row control unit 311, and the read control unit 332, and reads data from the physical page address to which the reset pulse is applied (step S931). The read data is transferred to and held in the read data buffer 342.

The request processing unit 360 supplies a control signal to the verifying processing unit 350, compares data held in the read data buffer 342 with write data held in the write data buffer 341 in units of bits, and executes the verifying process (step S932). A bit serving as a target of the verifying process is a bit in which the value of the data held in the write data buffer 341 represents “1.” A bit in which the value of the data held in the write data buffer 341 is “1” and the value held in the read data buffer 342 is “0” fails to be verified. A bit in which the value of the data held in the write data buffer 341 is “1” and the value held in the read data buffer 342 is “1” is successfully verified. As a result, information representing that “1” is set to the bit that has failed to be verified, “0” is set to the bit that has been successfully verified, and the value of “0” is set to the remaining bits is held in the verifying buffer 343.

When all bits of data held in the verifying buffer 343 represent “0,” all bits are determined to succeed in the verifying process (Yes in step S933), and the verifying processing unit 350 notifies the request processing unit 360 of this fact, and then ends the physical page reset process normally.

However, when any one of bits of the data held in the verifying buffer 343 represents “1,” all bits are determined to fail in the verifying process (No in step S933), and the retry operation of the reset process is performed. At this time, the value of the counter k is referred to, and when it is determined that the value of the counter k has reached “4” (Yes in step S934), the physical page reset process erroneously ends without performing the retry operation any more. When it is determined that the value of the counter k has not reached “4” (No in step S934), “1” is added to the value of the counter k (step S935), and the process of step S924 and subsequent steps is repeated.

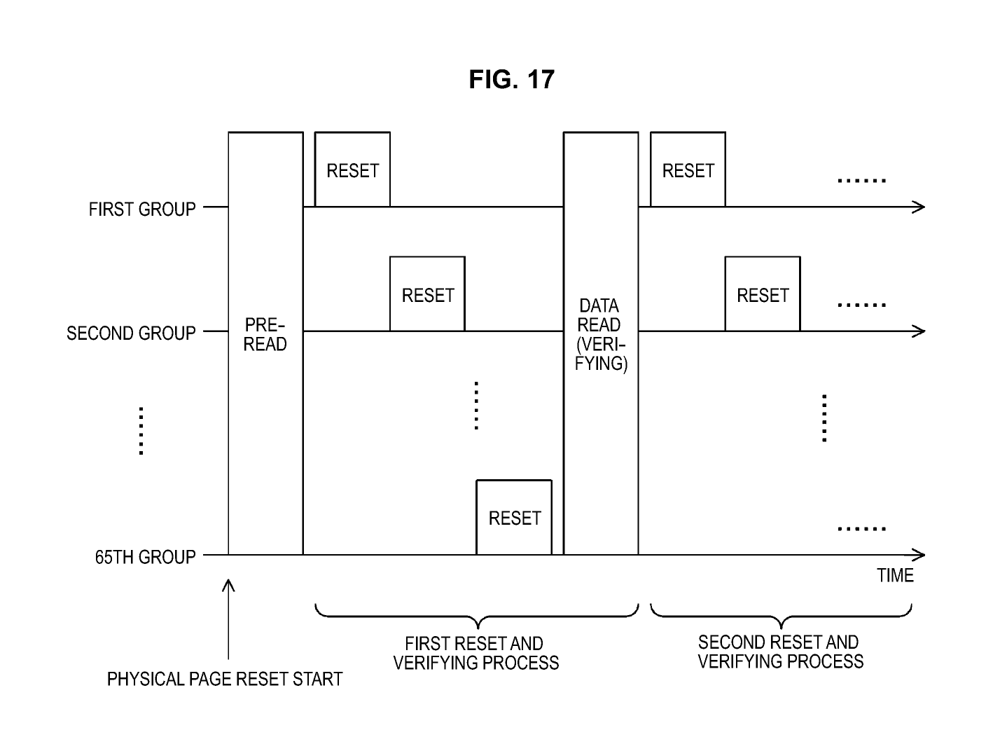

FIG. 17 is a diagram illustrating an exemplary progression of physical page resetting at the time of the write process according to the embodiment of the present technology.

When physical page resetting starts, pre-reading is performed on the entire physical page (step S921). Then, a memory cell serving as a reset target is specified (step S922), and then the reset process is performed for each group (step S925). When the reset process of from the first group to the 65th group is completed, the verifying process is performed on the entire physical page (step S932).

When verification has not successfully performed in the first verifying process, the reset process is performed again for each group (step S925), and then the verifying process is performed on the entire physical page (step S932).

As described above, in the write process, since bits of a memory cell to which a pulse is to be applied are all bits at maximum, when a current value is considered, the reset operation is performed for each group. For this reason, a time necessary for the reset operation increases.

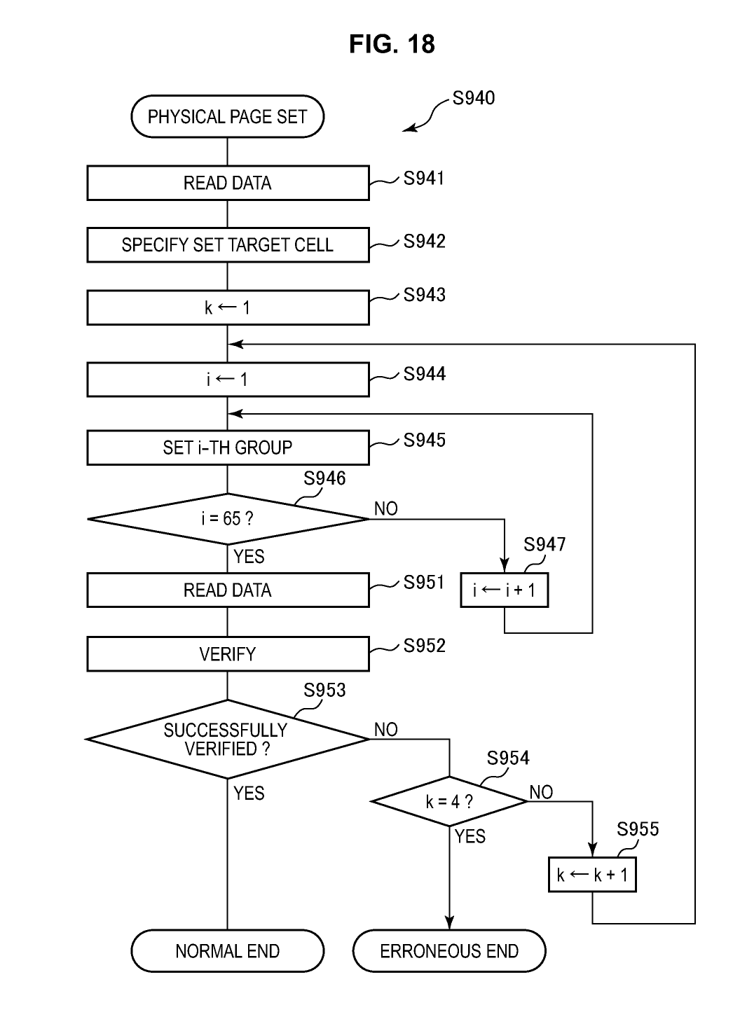

FIG. 18 is a diagram illustrating an example of a processing procedure of the physical page set process (step S940) according to the embodiment of the present technology.

The physical page set process is performed in a procedure similar to the physical page reset process described above with reference to FIG. 16. Here, in the physical page reset process, a memory serving as a reset target is specified in step S922, but in this physical page reset process, a memory serving as a reset target is specified in step S942. Further, the set process of each group is performed on the specified set target in step S945. The remaining points are similar to the physical page reset process described above with reference to FIG. 16, and thus a detailed description thereof will not be repeated.

[Read Process]

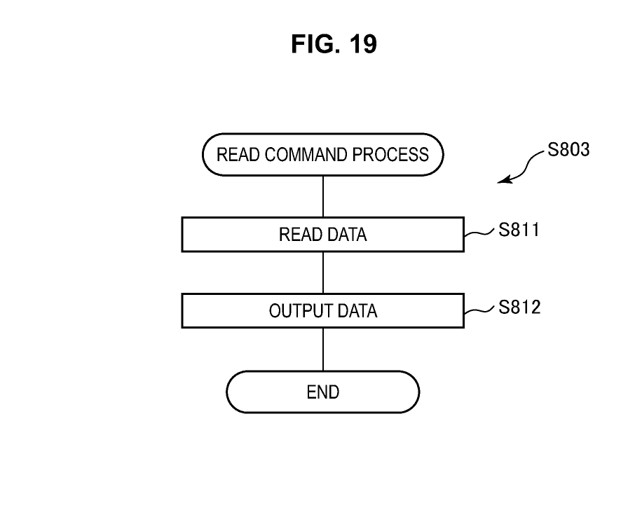

FIG. 19 is a diagram illustrating an example of a processing procedure of the read command process according to the embodiment of the present technology. As the read command process, the memory controller 200 transmits the read request to the memory 300. As a result, the request processing unit 360 performs a read operation by the following process.

Upon receiving the read request and the physical page address from the control interface 309, the request processing unit 360 starts the physical page read process. The read data is transferred to and held in the read data buffer 342 as read data.

The request processing unit 360 transfers the data held in the read data buffer 342 to the memory controller 200 through the control interface 309 (step S812). Thereafter, the request processing unit 360 ends the physical page read process.

[Refresh Process]

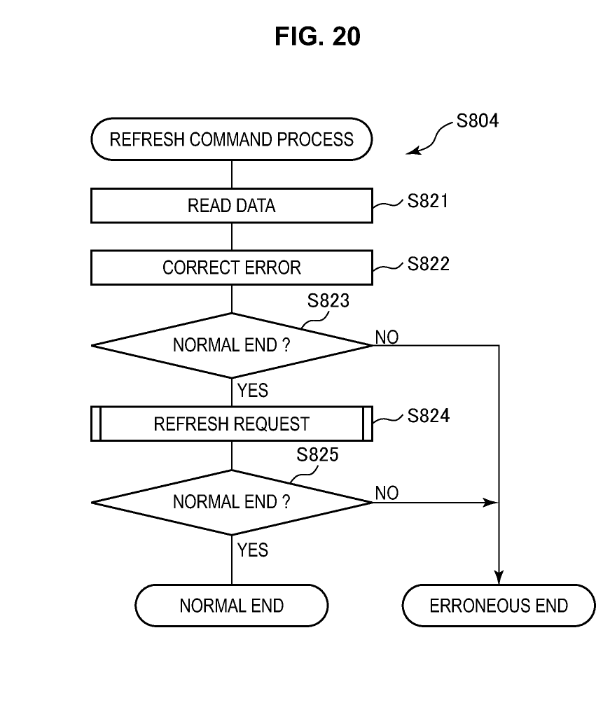

FIG. 20 is a diagram illustrating an example of a processing procedure of the refresh command process according to the embodiment of the present technology. Upon receiving the refresh command from the host computer 100, the memory controller 200 decomposes a range of a logical address designated by the refresh command in units of physical pages, and performs the following refresh operation for each physical page.

When the refresh operation has erroneously ended, the memory controller 200 suspends the refresh command, and notifies the host computer 100 of the fact that the refresh operation has erroneously ended. When the refresh operation has ended normally, the memory controller 200 continues the refresh operation until all physical pages in the range of the logical address designated by the refresh command end. After the entire physical page is refreshed, notification of the fact that the refresh operation has ended normally is transmitted to the host computer 100.

The processor 210 transmits the read request and the physical address to the memory 300 through the memory interface 203, and reads data (step S821). The processor 210 transfers the read data received from the memory interface 203 to be held in the RAM 220.

The ECC processing unit 240 executes a data error detection and correction process on the read data held in the RAM 220 (step S822). The error-corrected data is held in the RAM 220.

The processor 210 determines whether or not the error correction performed in step S822 has ended normally. In this example, when the number of detected errors is within 4 bits, the error correction ends normally. Further, it is also determined that the error correction has ended normally when no error is detected. When it is determined that the error correction has not ended normally (No in step S823), the refresh operation erroneously ends. When it is determined that the error correction has ended normally (Yes in step S823), the refresh request is transmitted to the memory 300 (step S824). In other words, in step S824, the processor 210 transmits the refresh request, the physical address, and the data, which has been subjected to error correction, held in the RAM 220 to the memory 300 through the memory interface 203. An address designated by the physical address is the same as the physical address at which reading is executed in step S821. The execution result of the refresh request is received through the memory interface 203.

The processor 210 determines whether or not the refresh request executed in step S824 has ended normally. When it is determined that the refresh request has ended normally (Yes in step S825), the refresh operation ends normally. When it is determined that the refresh request has not ended normally (No in step S825), the refresh operation erroneously ends.

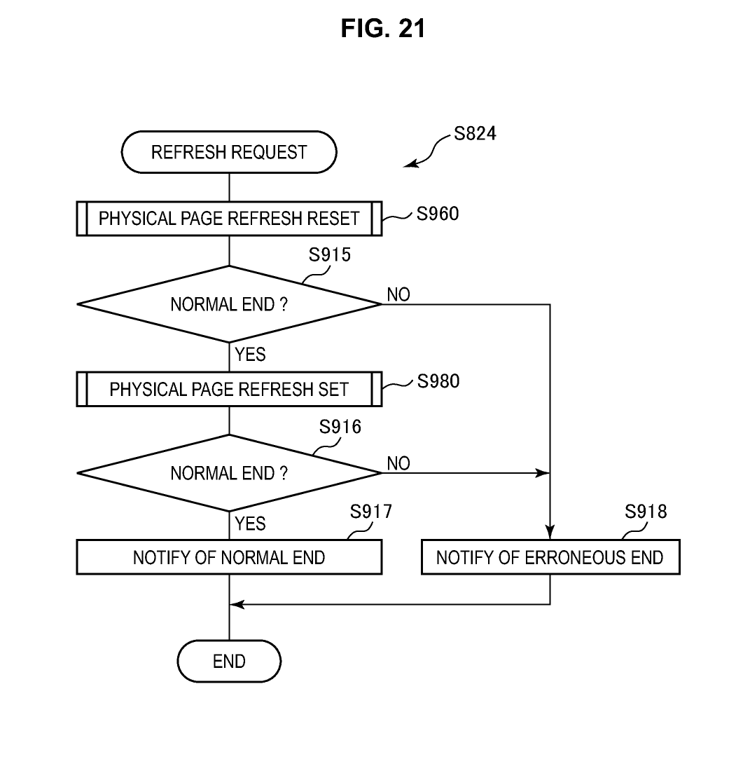

FIG. 21 is a diagram illustrating an example of a processing procedure of the refresh request process according to the embodiment of the present technology.

Upon receiving the refresh request and the physical page address from the control interface 309, the request processing unit 360 starts a physical page refresh process. When the physical page refresh process starts, data to be written in the memory cell array 310 remains corrected in step S822, is transferred from the control interface 309 to the write data buffer 341, and is held in the write data buffer 341.

The request processing unit 360 executes a physical page refresh reset process (step S960). Thereafter, the request processing unit 360 determines whether or not the physical page refresh reset process executed in step S960 has ended normally (step S915). At this time, when it is determined that the physical page refresh reset process has not ended normally (No in step S915), the request processing unit 360 notifies the memory controller 200 of the fact that the physical page refresh reset process has erroneously ended through the control interface 309 (step S918).

When it is determined that the physical page refresh reset process has ended normally (Yes in step S915), the request processing unit 360 executes a physical page refresh set process (step S980). Thereafter, the request processing unit 360 determines whether or not the physical page refresh set process executed in step S980 has ended normally (step S916). At this time, when it is determined that the physical page refresh set process has not ended normally (No in step S916), the request processing unit 360 notifies the memory controller 200 of the fact that the physical page refresh write process has erroneously ended through the control interface 309 (step S918).

When it is determined the physical page refresh set process has ended normally (Yes in step S916), the request processing unit 360 notifies the memory controller 200 of the fact that the physical page refresh write process has ended normally through the control interface 309 (step S917).

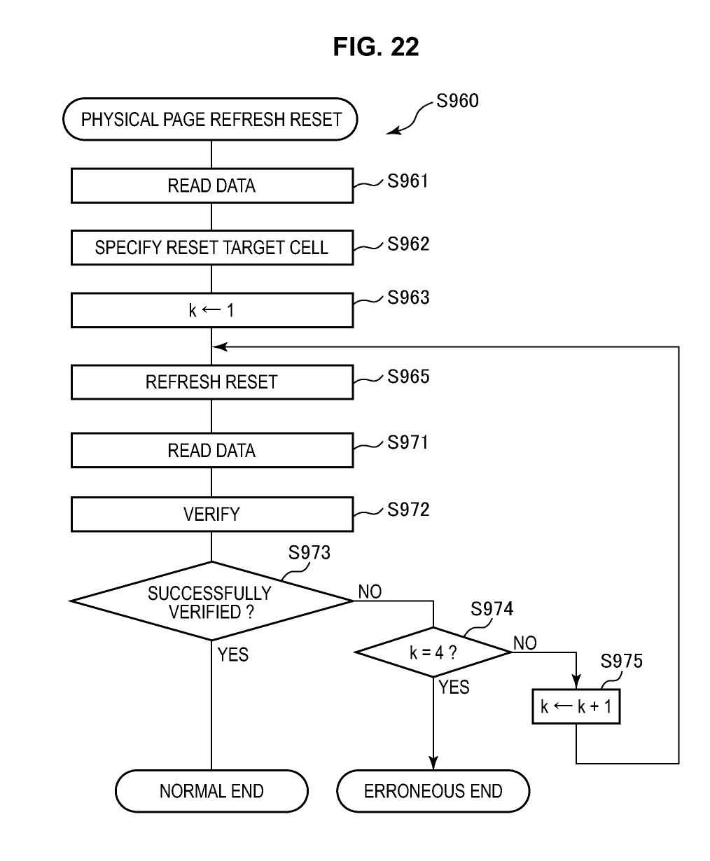

FIG. 22 is a diagram illustrating an example of a processing procedure of the physical page refresh reset process (step S960) according to the embodiment of the present technology.

The request processing unit 360 supplies a control signal to the plate control unit 320, the row control unit 311, and the read control unit 332, and reads data from a designated physical page address (step S961). The read data is transferred to and held in the read data buffer 342 as pre-read data.

The request processing unit 360 compares the pre-read data held in the read data buffer 342 with the write data held in the write data buffer 341 in units of bits, and specifies a memory cell on which a reset process is to be executed (step S962). The memory cell on which the reset process is to be executed is a memory cell in which a value of data held in the write data buffer 341 is “1,” and a value of data held in the read data buffer 342 is “0.” This means that it is necessary to change a state of a corresponding memory cell from “0” (the low resistive state) to “1” (the high resistive state). As information of the memory cell on which the reset process is to be executed, “1” is set as a value of a bit corresponding to a memory cell on which the reset process is to be executed, “0” is set as a value of a bit corresponding to a cell in which it is unnecessary to execute the reset process, and the values are held in the verifying buffer 343.

The request processing unit 360 sets a value of a counter k counting the number of times that setting and verifying are repeatedly executed “1” (step S963).

The request processing unit 360 supplies a control signal to the plate control unit 320, the row control unit 311, and the write control unit 331, and supplies information specifying a cell that is to be reset from the verifying buffer 343 to the column control unit 312. As a result, a reset pulse is applied to the memory cell array 310, and the reset operation is performed (step S965). Here, a memory cell to which the reset pulse is applied is a cell on which the reset process is to be executed among memory cells of a designated physical page address. That is, the reset process in this refresh process is to be performed on the entire physical page without being performed in units of groups as the reset process in the write.

In order to verify the reset operation, the request processing unit 360 supplies a control signal to the plate control unit 320, the row control unit 311, and the read control unit 332, and reads data from the physical page address to which the reset pulse is applied (step S971). The read data is transferred to and held in the read data buffer 342.

The request processing unit 360 supplies a control signal to the verifying processing unit 350, compares data held in the read data buffer 342 with write data held in the write data buffer 341 in units of bits, and executes the verifying process (step S972). A bit serving as a target of the verifying process is a bit in which the value of the data held in the write data buffer 341 represents “1.” A bit in which the value of the data held in the write data buffer 341 is “1” and the value held in the read data buffer 342 is “0” fails to be verified. A bit in which the value of the data held in the write data buffer 341 is “1” and the value held in the read data buffer 342 is “1” is successfully verified. As a result, information representing that “1” is set to the bit that has failed to be verified, “0” is set to the bit that has been successfully verified, and the value of “0” is set to the remaining bits is held in the verifying buffer 343.

When all bits of data held in the verifying buffer 343 represent “0,” all bits are determined to succeed in the verifying process (Yes in step S973), and the verifying processing unit 350 notifies the request processing unit 360 of this fact, and then ends the physical page refresh set process normally.

However, when any one of bits of the data held in the verifying buffer 343 represents “1,” all bits are determined to fail in the verifying process (No in step S933), and the retry operation of the reset process is performed. At this time, the value of the counter k is referred to, and when it is determined that the value of the counter k has reached “4” (Yes in step S974), the physical page refresh reset process erroneously ends without performing the retry operation any more. When it is determined that the value of the counter k has not reached “4” (No in step S974), “1” is added to the value of the counter k (step S975), and the process of step S965 and subsequent steps is repeated.

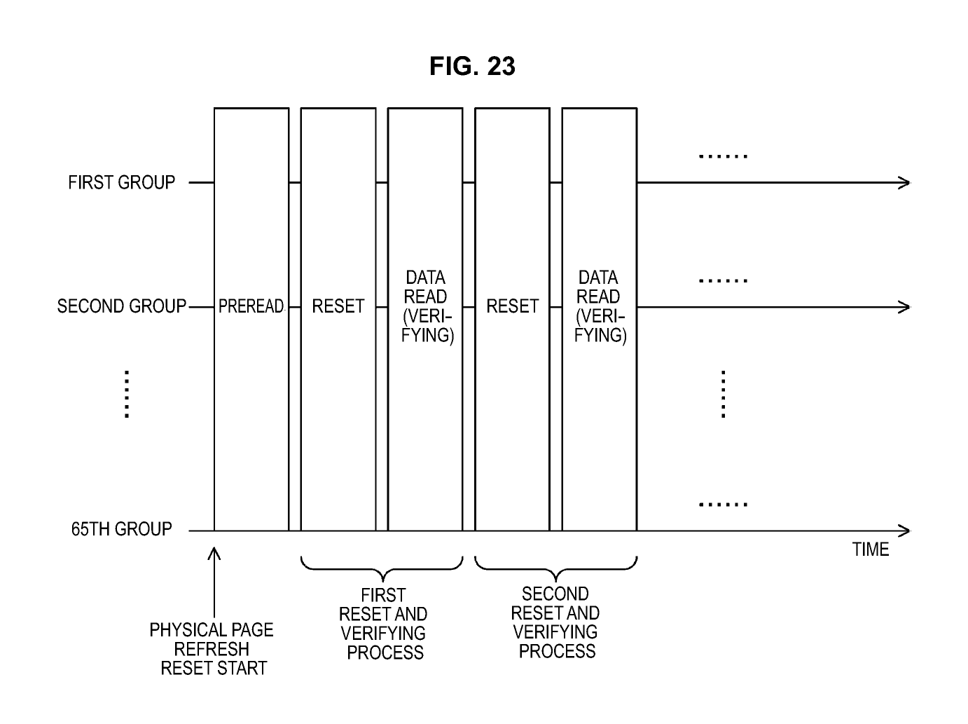

FIG. 23 is a diagram illustrating an exemplary progression of physical page refresh resetting at the time of a refresh process according to the embodiment of the present technology.

When physical page refresh resetting starts, pre-reading is performed on the entire physical page (step S961). Then, when a memory cell of a reset target is specified (step S962), the refresh reset process is performed on the entire physical page (step S965). Thereafter, the verifying process is performed on the entire physical page (step S972).

When verification is not successfully performed in the first verifying process, the refresh reset process is performed on the entire physical page again (step S965), and then the verifying process is performed on the entire physical page (step S972).

As described above, in the physical page refresh resetting, only the memory cell that has been subjected to the error correction is a pulse applying target, and thus in this example, it is a maximum of 4 bits in the entire physical page. Therefore, even when a current value is considered, the reset process on the entire physical page can be performed by a single process without performing it for each group, and thus the refresh process can be executed at a high speed.

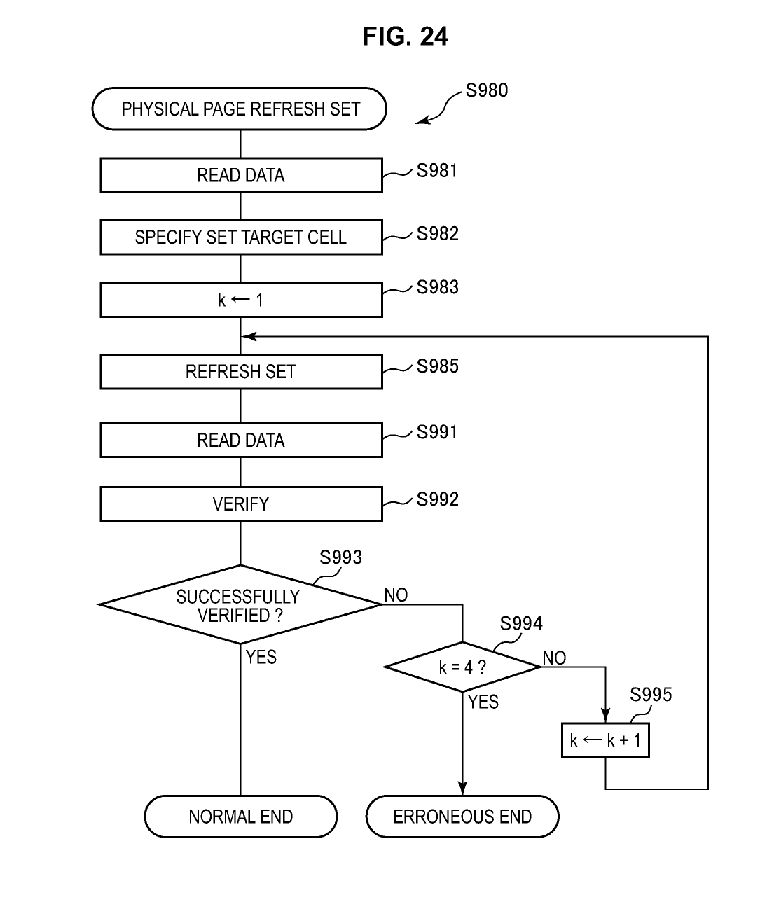

FIG. 24 is a diagram illustrating an example of a processing procedure of the physical page refresh set process (step S980) according to the embodiment of the present technology.

The physical page refresh set process is performed in a procedure similar to the physical page refresh set process described above with reference to FIG. 22. Here, in the physical page refresh set process, a memory serving as a reset target is specified in step S962, but in this physical page refresh set process, a memory serving as a reset target is specified in step S982. Further, the set process of each group is performed on the specified set target in step S985. The remaining points are similar to the physical page refresh set process described above with reference to FIG. 22, and thus a detailed description thereof will not be repeated.

As described above, according to the embodiment of the present technology, the reset operation and the set operation are performed on the entire physical page without being performed in units of groups as in the write process, and the refresh process can be executed at the high speed. Further, the number of memory cells to which a pulse is applied based on the refresh command is smaller than the number of memory cells to which a pulse is applied based on the write command Therefore, when the refresh command is used, stress applied to a memory cell can be reduced, and thus the lifespan of a memory can be expected to increase.

### 2. Modified Example

In the above embodiment, as illustrated in FIG. 5, reading is performed using the read threshold value that is at the intermediate position of the LRS and the HRS. On the other hand, in the case of refreshing, a more accurate threshold value is used, and thus the distribution of the resistive state can be improved as follows.

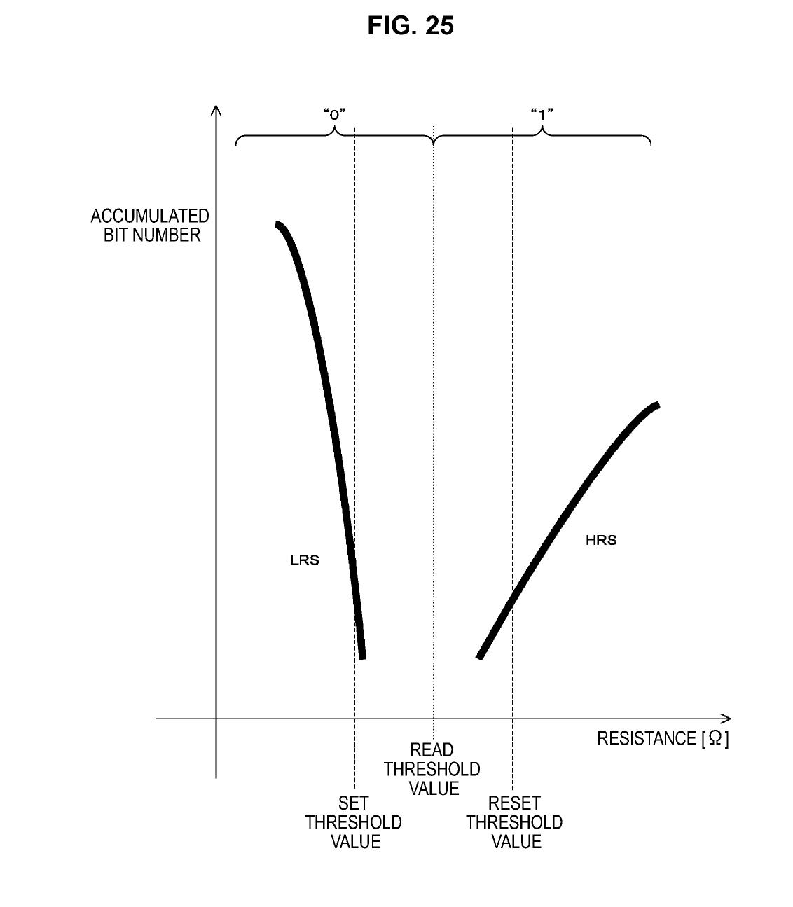

FIG. 25 is a diagram illustrating a relation between a resistance distribution and a threshold value of the memory cell 313 according to a modified example of the embodiment of the present technology. FIG. 25 illustrates a reset threshold value disposed on the HRS side and a set threshold value disposed on the LRS side in addition to the read threshold value that is at the intermediate position between the LRS and the HRS.

In the case of the refresh reset process, the read operation is performed in step S961 or S971 of FIG. 22. At this time, as the reset threshold value is used rather than the read threshold value, an area at the low resistance side of the HRS is regarded as the LRS. Thus, as the memory cell in the area of the low resistance side of the HRS is changed to the high resistance side of the HRS, a more stable status can be induced.

In the case of the refresh reset process, the read operation is performed in step S981 or S991 of FIG. 24. At this time, as the reset threshold value is used rather than the read threshold value, an area at the high resistance side of the LRS is regarded as the HRS. Thus, as the memory cell in the area of the high resistance side of the HRS is changed to the low resistance side of the LRS, a more stable status can be induced.

Further, in the above embodiment, when the refresh process is performed, writing is performed in units of physical pages, but writing may be performed in units of divided pages obtained by dividing the physical page. In this case, when writing is performed using a plurality of groups as a divided page, processing can be performed at a higher speed than when a single group is used as a unit as in the normal write process.

Further, the above embodiment has been described in connection with an implementation by the refresh process, but as long as a change bit number can be guaranteed to be smaller than in a limitation to a write current to a memory cell, the present technology can be applied to processing having a name other than the refresh process.

The embodiments of the present technology are examples to implement the present technology, and matters in the embodiment of the present technology have a correspondence relation with the subject matter set forth in the accompanying claims. Similarly, the subject matter set forth in the accompanying claims have a correspondence relation with matters in the embodiment of the present technology having the same names. However, the present technology is not limited to the above embodiments, and various changes can be made within the scope not departing from the gist of the present technology.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) A memory control device, including:

a request determining unit that determines a type of a request; and

a control unit that writes read data read from a memory cell array in the memory cell array in units of predetermined pages of the memory cell array when the request is a refresh request, and divides the page of write data into units of groups and writes the page of the write data in the memory cell array over twice or more when the request is a write request.
(2) The memory control device according to (1),

wherein a bit number of the group is decided based on an amount of current allowed in the memory cell array.
(3) The memory control device according to (1) or (2), further including:

an error processing unit that performs error detection of the read data,

wherein the control unit does not perform writing to the memory cell array when a number of errors detected in the error detection does not satisfy a predetermined requirement.
(4) The memory control device according to (1) or (2), further including:

an error processing unit that performs error detection and correction of the read data,

wherein the control unit does not perform writing to the memory cell array when a number of errors detected in the error detection is larger than an error correctable number.
(5) The memory control device according to any one of (1) to (4), further including:

a verifying processing unit that reads data from the memory cell array in units of pages after the data is written in response to the refresh request or the write request, and verifies whether or not writing has been properly performed.
(6) A memory device, including:

a memory cell array including a plurality of memory cells;

a request determining unit that determines a type of a request; and

a control unit that writes read data read from the memory cell array in the memory cell array in units of predetermined pages of the memory cell array when the request is a refresh request, and divides the page of write data into units of groups and writes the page of the write data in the memory cell array over twice or more when the request is a write request.
(7) An information processing system, including:

a memory cell array including a plurality of memory cells;

a host computer that issues a command to the memory cell array;

a command determining unit that determines a type of the command; and

a control unit that writes read data read from the memory cell array in the memory cell array in units of predetermined pages of the memory cell array when the command is a refresh command, and divides the page of write data into units of groups and writes the page of the write data in the memory cell array over twice or more when the command is a write command.
(8) A memory control method, including:

determining a type of a request; and

writing read data read from a memory cell array in the memory cell array in units of predetermined pages of the memory cell array when the request is a refresh request, and dividing the page of write data into units of groups and writing the page of the write data in the memory cell array over twice or more when the request is a write request.

The present disclosure contains subject matter related to that disclosed in Japanese Priority Patent Application JP 2012-184743 filed in the Japan Patent Office on Aug. 24, 2012, the entire content of which is hereby incorporated by reference.

What is claimed is:

1. A memory control device, comprising:
a request determining unit that determines a type of a request; and
a control unit that writes read data read from a memory cell array in the memory cell array in units of predetermined pages of the memory cell array when the request is a refresh request, and divides the page of write data into units of groups and writes the page of the write data in the memory cell array over twice or more when the request is a write request.

2. The memory control device according to claim 1,
wherein a bit number of the group is decided based on an amount of current allowed in the memory cell array.

3. The memory control device according to claim 1, further comprising:
an error processing unit that performs error detection of the read data,
wherein the control unit does not perform writing to the memory cell array when a number of errors detected in the error detection does not satisfy a predetermined requirement.

4. The memory control device according to claim 1, further comprising:
an error processing unit that performs error detection and correction of the read data,
wherein the control unit does not perform writing to the memory cell array when a number of errors detected in the error detection is larger than an error correctable number.

5. The memory control device according to claim 1, further comprising:
a verifying processing unit that reads data from the memory cell array in units of pages after the data is written in response to the refresh request or the write request, and verifies whether or not writing has been properly performed.

6. A memory device, comprising:
a memory cell array including a plurality of memory cells;
a request determining unit that determines a type of a request; and
a control unit that writes read data read from the memory cell array in the memory cell array in units of predetermined pages of the memory cell array when the request is a refresh request, and divides the page of write data into units of groups and writes the page of the write data in the memory cell array over twice or more when the request is a write request.

7. An information processing system, comprising:
a memory cell array including a plurality of memory cells;
a host computer that issues a command to the memory cell array;
a command determining unit that determines a type of the command; and
a control unit that writes read data read from the memory cell array in the memory cell array in units of predetermined pages of the memory cell array when the command is a refresh command, and divides the page of write data into units of groups and writes the page of the write data in the memory cell array over twice or more when the command is a write command.

8. A memory control method, comprising:
determining a type of a request; and
writing read data read from a memory cell array in the memory cell array in units of predetermined pages of the memory cell array when the request is a refresh request, and dividing the page of write data into units of groups and writing the page of the write data in the memory cell array over twice or more when the request is a write request.
